(19) United States
(12) Patent Application Publication
(10) Pub. No.: US 2016/0255371 A1
(43) Pub. Date: Sep. 1, 2016

(54) METHOD AND APPARATUS FOR CODING/DECODING 3D VIDEO

(71) Applicant: LG ELECTRONICS INC., Seoul (KR)

(72) Inventors: Jin HEO, Seoul (KR); Sehoon YEA, Seoul (KR); Taesup KIM, Seoul (KR); Junghak NAM, Seoul (KR)

(21) Appl. No.: 15/029,941

(22) PCT Filed: Oct. 20, 2014
(86) PCT No.: PCT/KR2014/009855

§ 371 Date: Apr. 15, 2016

Related U.S. Application Data
(60) Provisional application No. 61/892,465, filed on Oct. 18, 2013.

(51) Int. Cl. H04N 19/597; H04N 19/11

(52) U.S. Cl. CPC H04N 19/597; H04N 19/11

(57) ABSTRACT

The present invention provides a method for coding and decoding a 3D video comprising a depth-map picture. The method for coding a 3D video, according to one embodiment of the present invention, comprises the steps of: inducing a first index value with respect to a first sample of a current block by mapping a depth lookup table (DLT) on a predicted depth value of the first sample of the current block which has been induced based on an intra-prediction mode of the current block in a depth map picture; inducing a second index value with respect to the first sample of the current block by mapping the DLT on an original depth value of the first sample of the current block; inducing a residual index value between the first index value and the second index value with respect to the first sample of the current block; and transforming, quantizing, and entropy-coding the residual index value.

### BACKGROUND OF THE INVENTION

1. Field of the Invention

The present invention relates to a technology associated with video coding, and more particularly, to coding of a 3D video picture.

2. Related Art

In recent years, demands for a high-resolution and high-quality video have increased in various fields of applications. However, the higher the resolution and quality video data becomes, the greater the amount of video data becomes.

Accordingly, when video data is transferred using media such as existing wired or wireless broadband lines or video data is stored in existing storage media, the transfer cost and the storage cost thereof increase. High-efficiency video compressing techniques can be used to effectively transfer, store, and reproduce high-resolution and high-quality video data.

On the other hand, with realization of capability of processing a high-resolution/high-capacity video, digital broadcast services using a 3D video have attracted attention as a next-generation broadcast service. A 3D video can provide a sense of realism and a sense of immersion using multi-view channels.

A 3D video can be used in various fields such as free viewpoint video (FVV), free viewpoint TV (FTV), 3DTV, surveillance, and home entertainments.

Unlike a single-view video, a 3D video using multi-views have a high correlation between views having the same picture order count (POC). Since the same scene is shot with multiple neighboring cameras, that is, multiple views, multi-view videos have almost the same information except for a parallax and a slight illumination difference and thus difference views have a high correlation therebetween.

Accordingly, the correlation between different views can be considered for coding/decoding a multi-view video, and information need for coding and/or decoding of a current view can be obtained. For example, a block to be decoded in a current view can be predicted or decoded with reference to a block in another view.

### SUMMARY OF THE INVENTION

The present invention provides a method and an apparatus for coding/decoding a 3D video including a depth-map picture.

The present invention provides a method and an apparatus for coding/decoding a 3D video including a depth lookup table.

In one aspect, a method for coding a 3D video including a depth-map picture is provided. The method for coding a 3D video includes: deriving a first index value with respect to a first sample of a current block by mapping a predicted depth value of the first sample of the current block on a depth lookup table (DLT), wherein the predicted depth value of the first sample has been induced based on an intra-prediction mode of the current block in a depth-map picture; deriving a second index value with respect to the first sample of the current block by mapping an original depth value of the first sample of the current block on the DLT; deriving a residual index value between the first index value and the second index value with respect to the first sample of the current block; and transforming, quantizing, and entropy-coding the residual index value.

In another aspect, a method for decoding a 3D video including a depth-map picture is provided. The method for decoding a 3D video includes: acquiring a residual index value for a current block in the depth-map picture through entropy-decoding, dequantization, and inverse transformation; deriving a predicted depth value of a first sample in the current block based on an intra prediction mode of the current block; deriving a first index value for the first sample in the current blocking by mapping the predicted depth value of the first sample of the current block on a DLT; and acquiring the depth value of the first sample of the current block by adding the first index value and the residual index value with respect to the first sample of the current block.

The depth value of the first sample of the current block may be a value acquired by mapping a second index value derived by adding the first index value and the residual index value to the DLT.

According to the present invention, coding and decoding are performed by using a depth lookup table (DLT) to reduce complexities of an encoder and a decoder and improve coding/decoding efficiency.

### BRIEF DESCRIPTION OF THE DRAWINGS

FIG. 1 is a diagram scheduling describing encoding and decoding processes of a 3D video.

FIG. 2 is a diagram schematically describing a configuration of a video encoding apparatus.

FIG. 3 is a diagram schematically describing a configuration of a video decoding apparatus.

FIG. 4 is a diagram for schematically describing an intra prediction method of a depth map in a depth modeling mode (DMM).

FIG. 5 is a flowchart schematically illustrating a method for encoding by applying intra prediction using a DLT according to an embodiment of the present invention.

FIG. 6 is a flowchart schematically illustrating a method for selecting an optimal intra prediction mode according to an embodiment of the present invention.

FIG. 7 is a flowchart schematically illustrating a method for decoding by applying intra prediction using a DLT according to an embodiment of the present invention.

### DESCRIPTION OF EXEMPLARY EMBODIMENTS

The invention may be variously modified in various forms and may have various embodiments, and specific embodiments thereof will be illustrated in the drawings and described in detail. However, these embodiments are not intended for limiting the invention. Terms used in the below description are used to merely describe specific embodiments, but are not intended for limiting the technical spirit of the invention. An expression of a singular number includes an expression of a plural number, so long as it is clearly read differently. Terms such as “include” and “have” in this description are intended for indicating that features, numbers, steps, operations, elements, components, or combinations thereof used in the below description exist, and it should be thus understood that the possibility of existence or addition of one or more different features, numbers, steps, operations, elements, components, or combinations thereof is not excluded.

On the other hand, elements of the drawings described in the invention are independently drawn for the purpose of convenience of explanation on different specific functions, and do not mean that the elements are embodied by independent hardware or independent software. For example, two or more elements out of the elements may be combined to form a single element, or one element may be split into plural elements. Embodiments in which the elements are combined and/or split belong to the scope of the invention without departing from the concept of the invention.

In the specification, a pixel or a pel may mean a minimum unit constituting one picture. Further, a ‘sample’ may be used as a term indicating a value of a specific pixel. The sample generally indicates the pixel of the pixel, but may indicate only a pixel value of a luminance (luma) component or indicate only a pixel value of a chroma component.

A unit may mean a base unit of picture processing or a specific position of a picture. The unit may be used mixedly with a term such as a block or an area in some cases. In a general case, an M×N block may indicate a set of samples constituted by M columns and N rows or transform coefficients.

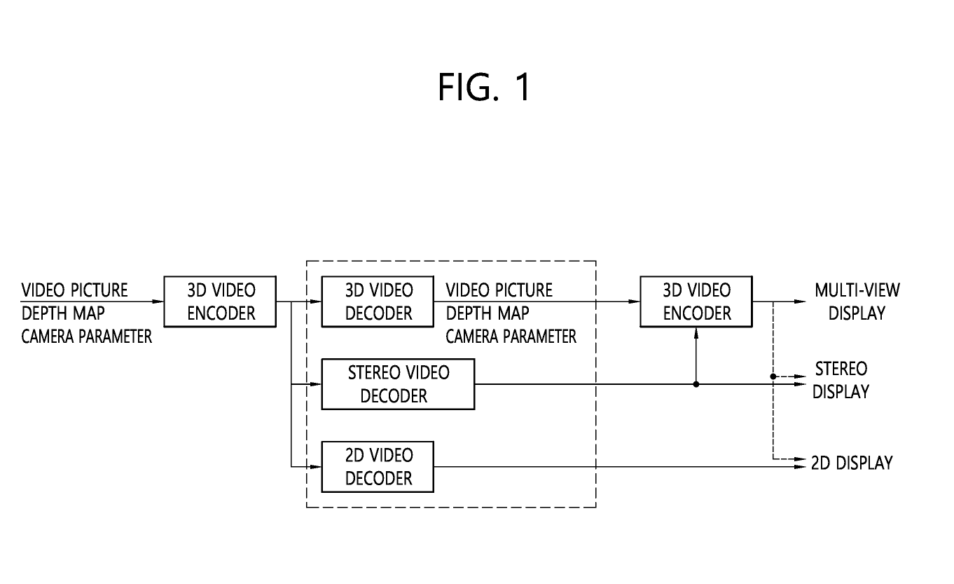

FIG. 1 is a diagram scheduling describing encoding and decoding processes of a 3D video.

Referring to FIG. 1, a 3 video encoder encodes a video picture and a depth and a camera parameter to output the same as a bitstream.

The depth map may be constituted by distance information (depth information) between a camera and a subject with respect to a pixel of the corresponding video picture (texture picture). For example, the depth map may be a picture acquired by normalizing the depth information according to a bit depth. In this case, the depth map may be constituted by the depth information recorded without expression of a chrominance.

In general, since a distance from the subject and a disparity are in inverse proportion to each other, disparity information indicating a correlation between views may be induced from the depth information of the depth map by using the camera parameter.

A bitstream including the depth map and camera information together with a general color picture, that is, the video picture (texture picture) may be transmitted to a decoder through a network or a storage medium.

The decoder receives the bitstream to reconstruct the video. When a 3D video decoder is used as the decoder, the 3D video decoder may decode the video picture, and the depth map and the camera parameter from the bitstream. Views required for a multi-view display may be synthesized based on the decoded video picture, depth map, and camera parameter. In this case, when the used display is a stereo display, the 3D picture may be displayed by using two pictures among the reconstructed multi-views.

When the stereo video decoder is used, the stereo video decoder may reconstruct two pictures to be incident in both eyes from the bitstream. The stereo display may display a 3D picture by using a view difference or disparity between a left picture incident in a left eye and a right picture incident in a right eye. When the multi-view display is used together with the stereo video decoder, the multi-views may be displayed by generating other views based on the two reconstructed pictures.

When a 2D decoder is used, a 2D picture is reconstructed to output the picture through a 2D display. The 2D display is used, but when the 3D video decoder or the stereo video decoder is used as the decoder, one of the reconstructed pictures may be output through the 2D display.

In the configuration of FIG. 1, the view synthesis may be performed by the decoder or the display. Further, the decoder and the display may be one apparatus or separate apparatuses.

In FIG. 1, for easy description, it is described that the 3D video decoder, the stereo video decoder, and the 2D video decoder are separate decoders, but one decoding apparatus may perform all 3D video decoding, stereo video decoding, and 2D video decoding. Further, a 3D video decoding apparatus may perform the 3D video decoding, a stereo video decoding apparatus may perform the stereo video decoding, and a 2D video decoding apparatus may perform the 2D video decoding. Furthermore, the multi-view display may output a 2D video or a stereo video.

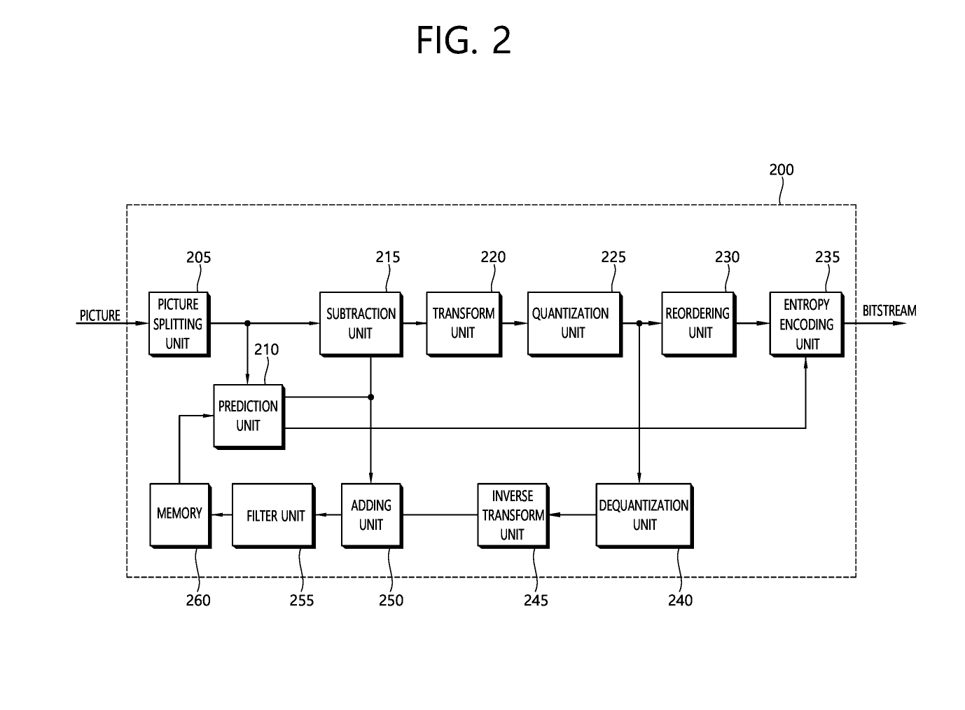

FIG. 2 is a diagram schematically describing a configuration of a video encoding apparatus.

Referring to FIG. 2, the video encoding apparatus 200 includes a picture splitting unit 205, a prediction unit 210, a subtraction unit 215, a transform unit 220, a quantization unit 225, a reordering unit 230, an entropy encoding unit 235, an dequantization unit 240, an inverse transform unit 245, an adding unit 250, a filter unit 255, and a memory 260.

The picture splitting unit 05 may split an input picture into at least one processing unit block. In this case, the processing unit block may be a coding unit block, a prediction unit block, or a transform unit block. The coding unit block as a unit block of coding may be split from a maximum coding unit block according to a quad tree structure. The prediction unit block as a block partitioned from the coding unit block may be a unit block of sample prediction. In this case, the prediction unit block may be divided into sub blocks. The transform unit bock as the coding unit block may be split according to the quad tree structure and may be a unit block to induce a transform coefficient or a unit block to induce a residual signal from the transform coefficient.

Hereinafter, for easy description, the coding unit block is referred to as a coding block or a coding unit, and the prediction unit block is referred to as a prediction block or a prediction unit, and the transform unit block is referred to as a transformation block or a transform unit.

The prediction block or the prediction unit may mean a block-shape specific area or an array of the prediction sample. Further, the transformation block or the transform unit may mean the block-shape specific area or an array of the transform coefficient or a residual sample.

The prediction unit 210 may perform a prediction for a processing target block (hereinafter, referred to as a current block) and generate the prediction block including prediction samples for the current block. A unit of the prediction performed by the prediction unit 210 may be the coding block, the transformation block, or the prediction block.

The prediction unit 210 may decide whether an intra prediction is applied to the current block or whether an inter prediction is applied to the current block.

In the case of the intra prediction, the prediction unit 210 may induce the prediction sample for the current block based on a neighbor block pixel in a picture (hereinafter, a current picture) to which the current block belongs. In this case, the prediction unit 210 may (i) induce the prediction sample based an average or an interpolation of neighbor reference samples of the current block or (ii) induce the prediction sample based on a reference sample which is present in a specific direction with respect to a prediction target pixel among neighbor blocks of the current block. For easy description, the case of (i) is referred to as a non-directional mode and the case of (ii) is referred to as a directional mode. The prediction unit 210 may decide a prediction mode applied to the current block by using the prediction mode applied to the neighbor block.

In the case of the inter prediction, the prediction unit 210 may induce the prediction sample for the current block based on samples specified by a motion vector on a collocated picture. The prediction unit 10 applies any one of a skip mode, a merge mode, and an MVP mode to induce the prediction sample for the current block. In the cases of the skip mode and the merge mode, the prediction unit 210 may use motion information of the neighbor block as the motion information of the current block. In the case of the skip mode, a difference (residual) between the prediction sample and an original sample is not transmitted unlike the merge mode. In the case of the MVP mode, the motion vector of the neighbor block is used as a motion vector predictor (MVP) to induce the motion vector of the current block.

In the case of the inter prediction, the neighbor block includes a spatial neighbor block which is present in the current picture and a spatial neighbor block which is present in the collocated picture. The motion information includes the motion vector and the collocated picture. In the skip mode and the merge mode, when the motion information of the spatial neighbor block is used, a highest picture on a collocated picture list may be used as the collocated picture.

In the case of encoding a dependent view, the prediction unit 210 may perform an inter-view prediction.

The prediction unit 210 may configure the collocated picture list including a picture of another view. For the inter-view prediction, the prediction unit 210 may induce a disparity vector. Unlike a motion vector specifying a block corresponding to the current block in another picture in a current view, the disparity vector may specify a block corresponding to the current block in another view of the same access unit as the current picture.

The prediction unit 10 may specify a depth block in a depth view based on the disparity vector and perform a configuration of a merge list, an inter-view motion prediction, an illumination compensation (IC), view synthesis, and the like.

The disparity vector for the current block may be induced from a depth value by using the camera parameter or induced from the motion vector or disparity vector of the neighbor block in the current or another view.

For example, the prediction unit 210 may add to a merge candidate list an inter-view merging candidate (IvMC) corresponding to spatial motion information of a reference view, an inter-view disparity vector candidate (IvDC) corresponding to the disparity vector, a shifted IvMC induced by a shift of the disparity, a texture merging candidate (T) induced from a texture corresponding to a case in which the current block is a block on the depth map, a disparity derived merging candidate (D) derived from the texture merging candidate by using the disparity, a view synthesis prediction merge candidate (VSP) derived based on the view synthesis, and the like.

In this case, the number of candidates included in a merge candidate list applied to the dependent view may be limited to a predetermined value.

Further, the prediction unit 210 may predict the motion vector of the current block based on the disparity vector by applying the inter-view motion vector prediction. In this case, the prediction unit 210 may derive the disparity vector based on conversion of a maximum depth value in the corresponding depth block. When a position of the reference sample in the reference view is specified by adding the disparity vector to a sample position of the current block in the reference view, a block including the reference sample may be used as the reference block. The prediction unit 210 may use the motion vector of the reference block as a candidate motion parameter or a motion vector predictor candidate of the current block and use the disparity vector as a candidate disparity vector for the DCP.

The subtraction unit 215 generates the residual sample which is the difference between the original sample and the prediction sample. When the skip mode is applied, the subtraction unit 215 may not generate the residual sample as described above.

The transform unit 210 generates the transform coefficient by using transforming the residual sample by the unit of the transform block. The quantization unit 225 quantizes the transform coefficients to generate quantized transform coefficients.

The reordering unit 230 reorders the quantized transform coefficients. The reordering unit 230 may reorder the block-shape quantized transform coefficients in a 1D vector shape through a scanning method.

The entropy encoding unit 235 may perform entropy-encoding of the quantized transform coefficients. As the entropy encoding, encoding methods including, for example, exponential Golomb, context-adaptive variable length coding (CAVLC), context-adaptive binary arithmetic coding (CABAC), and the like may be used. The entropy encoding unit 235 may encode information (e.g., a value of a syntax element, and the like) required for video reconstruction together or separately in addition to the quantized transform coefficients.

The entropy-encoded information may be transmitted or stored by the unit of a network abstraction layer as the form of the bitstream.

The dequantization unit 240 dequantizes the quantized transform coefficient to generate the transform coefficient. The inverse transform unit 245 inversely transforms the transform coefficient to generate the residual sample.

The adding unit 250 adds the residual sample and the prediction sample to reconstruct the picture. The residual sample and the prediction sample are added to each other by the unit of the block to generate a reconstruction block. Herein, the adding unit 250 is described as a separate component, but the adding unit 250 may be a part of the prediction unit 210.

The filter unit 255 may apply a deblocking filter and/or offset to the reconstructed picture. Distortion during an artifact or a quantization process of a block boundary in the reconstructed picture may be corrected through the deblocking filtering and/or offset. The offset may be applied by the unit of the sample and applied after the process of the deblocking filtering is completed.

The memory 260 may store the reconstructed picture or information required for encoding/decoding. For example, the memory 60 may store pictures used for the inter prediction/inter-view prediction. In this case, the pictures used for the inter prediction/inter-view prediction may be designated by a collocated picture set or a collocated picture list.

Herein, it is described that one encoding apparatus encodes an independent view or the dependent view, but this is for easy description and a separate encoding apparatus is configured for each view or a separate internal module (for example, a prediction unit for each view) may be configured for each view.

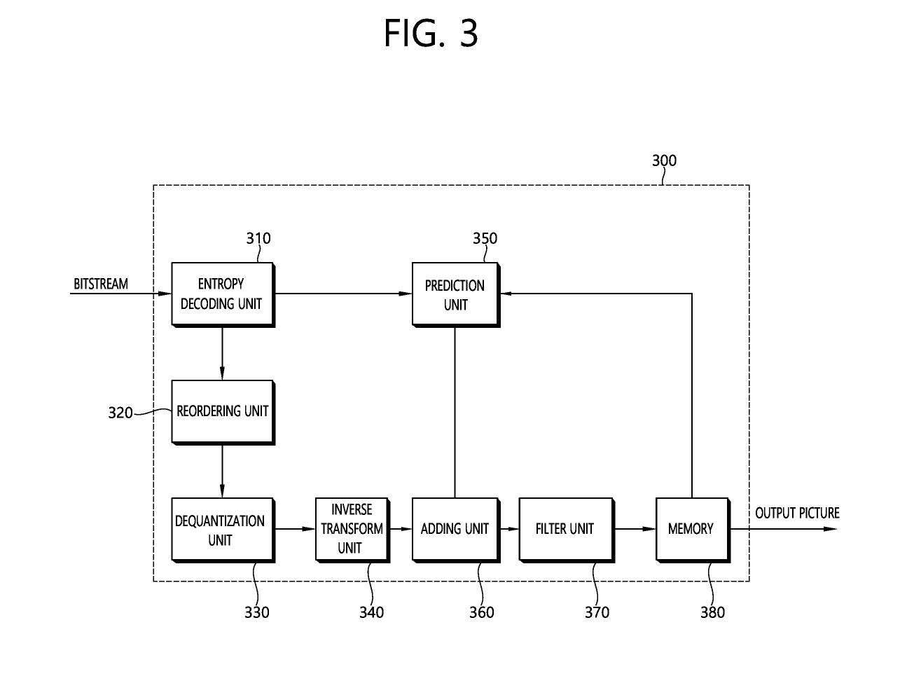

FIG. 3 is a diagram schematically describing a configuration of a video decoding apparatus.

Referring to FIG. 3, the video decoding apparatus 300 includes an entropy decoding unit 310, a reordering unit 320, a dequantization unit 330, an inverse transform unit 340, a prediction unit 350, an adding unit 360, a filter unit 370, and a memory 380.

When a bitstream including video information is input, the video decoding apparatus 300 may reconstruct a video to correspond to a process in which the video information is processed by the video encoding apparatus.

For example, the video decoding apparatus 300 may perform video decoding by using the processing unit applied in the video encoding apparatus. In this case, the processing unit block of the video decoding may be the coding unit block, the prediction unit block, or the transform unit block. The coding unit block as a unit block of decoding may be split from the maximum coding unit block according to the quad tree structure. The prediction unit block as the block partitioned from the coding unit block may be the unit block of sample prediction. In this case, the prediction unit block may be divided into sub blocks. The transform unit bock as the coding unit block may be split according to the quad tree structure and may be a unit block to derive a transform coefficient or a unit block to derive a residual signal from the transform coefficient.

The entropy decoding unit 310 parses the bitstream to output information required for video reconstruction or picture reconstruction. For example, the entropy decoding unit 310 may decode information in the bitstream based on the exponential Golomb, the CAVLC, the CABAC, and the like and output the value of the syntax element required for the video reconstruction, the quantized value of the transform coefficient associated with the residual, and the like.

When a plurality of views is processed in order to reproduce the 3D video, the bitstream may be input for each view. Alternatively, information on the respective views may be multiplexed in the bitstream. In this case, the entropy decoding unit 310 de-multiplexes the bitstream to parse the de-multiplexed bitstream for each view.

The reordering unit 320 may reorder the quantized transform coefficients in the 2D block form. The reordering unit 320 may perform reordering to correspond to coefficient scanning performed by the encoding apparatus.

The dequantization unit 330 dequantizes the quantized transform coefficients based on (de)quantized parameters to output the transform coefficients. Information for deriving the quantized parameters may be signaled from the encoding apparatus.

The inverse transform unit 340 inversely transforms the transform coefficients to derive the residual samples.

The prediction unit 350 may perform a prediction for the current block and generate the prediction block including prediction samples for the current block. A unit of the prediction performed by the prediction unit 350 may be the coding block, the transformation block, or the prediction block.

The prediction unit 350 may decide whether the intra prediction is applied to the current block or whether the inter prediction is applied to the current block. In this case, a unit for deciding which the intra prediction or the inter prediction is applied and a unit for generating the prediction sample may be different from each other. Moreover, the units for generating the prediction sample in the inter prediction and the intra prediction may also be different from each other.

In the case of the intra prediction, the prediction unit 350 may derive the prediction sample for the current block based on the neighbor block pixel in the current picture. The prediction unit 350 may derive the prediction sample for the current block by applying the directional mode or the non-directional mode based on neighbor reference blocks of the current block. In this case, the prediction mode to be applied to the current block may be decided by using an intra prediction mode of the neighbor block.

In the case of the inter prediction, the prediction unit 350 may derive the prediction sample for the current block based on the samples specified by the motion vector on the collocated picture. The prediction unit 10 applies any one of the skip mode, the merge mode, and the MVP mode to derive the prediction sample for the current block.

In the cases of the skip mode and the merge mode, the prediction unit 350 may use the motion information of the neighbor block as the motion information of the current block. In this case, the neighbor block may include a spatial neighbor block and a temporal neighbor block.

The prediction unit 350 may configure the merge candidate list as motion information of an available neighbor block and information indicated by a merge index on the merge candidate list may be used as the motion vector of the current block. The merge index may be signaled from the encoding apparatus. The motion information includes the motion vector and the collocated picture. In the skip mode and the merge mode, when the motion information of the temporal neighbor block is used, the highest picture on the collocated picture list may be used as the collocated picture.

In the case of the skip mode, the difference (residual) between the prediction sample and the original sample is not transmitted unlike the merge mode.

In the case of the MVP mode, the motion vector of the neighbor block is used as the motion vector predictor (MVP) to derive the motion vector of the current block. In this case, the neighbor block may include the spatial neighbor block and the temporal neighbor block.

In the case of encoding the dependent view, the prediction unit 350 may perform the inter-view prediction. In this case, the prediction unit 350 may configure the collocated picture list including the picture of another view.

For the inter-view prediction, the prediction unit 350 may derive the disparity vector. The prediction unit 350 may specify the depth block in the depth view based on the disparity vector and perform the configuration of the merge list, the inter-view motion prediction, the illumination compensation (IC), the view synthesis, and the like.

The disparity vector for the current block may be derived from the depth value by using the camera parameter or derived from the motion vector or disparity vector of the neighbor block in the current or another view. The camera parameter may be signaled from the encoding apparatus.

When the merge mode is applied to the current block of the dependent view, the prediction unit 350 may add to the merge candidate list IvDC corresponding to the temporal motion information of the reference view, IvDC corresponding to the disparity vector, shift IvMC derived by the shift of the disparity vector, the texture merge candidate (T), derived from the texture corresponding to the case in which the current block is the block on the depth map, the disparity derive merge candidate (D) derived from the texture merge candidate by using the disparity, the view synthesis prediction merge candidate (VSP) derived based on the view synthesis, and the like.

In this case, the number of candidates included in the merge candidate list applied to the dependent view may be limited to a predetermined value.

Further, the prediction unit 350 may predict the motion vector of the current block based on the disparity vector by applying the inter-view motion vector prediction. In this case, the prediction unit 350 may use the block in the reference view specified by the disparity vector as the reference block. The prediction unit 350 may use the motion vector of the reference block as the candidate motion parameter or the motion vector predictor candidate of the current block and use the disparity vector as the candidate disparity vector for the DCP.

The adding unit 360 adds the residual sample and the prediction sample to reconstruct the current block or the current picture. The adding unit 360 adds the residual sample and the prediction sample by the unit of the block to reconstruct the current picture. When the skip mode is applied, since the residual is not transmitted, the prediction sample may become a reconstruction sample. Herein, the adding unit 360 is described as a separate component, but the adding unit 360 may be a part of the prediction unit 350.

The filter unit 370 may apply the deblocking filtering and/or offset to the reconstructed picture. In this case, the offset may be adaptively applied as the offset of the sample unit.

The memory 380 may store the reconstructed picture or information required for decoding. For example, the memory 380 may store pictures used for the inter prediction/inter-view prediction. In this case, the pictures used for the inter prediction/inter-view prediction may be designated by the collocated picture set or the collocated picture list. The reconstructed picture may be used as the collocated picture.

Further, the memory 380 may output the reconstructed pictures according to an output order. In order to reproduce the 3D picture, although not illustrated, an output unit may display a plurality of different views.

In the example of FIG. 3, it is described that one decoding apparatus decodes the independent view and the dependent view, but this is for easy description and the present invention is not limited thereto. For example, each decoding apparatus may operate for each view and one decoding apparatus may include an operating unit (for example, a prediction unit) corresponding to each view therein.

Meanwhile, the 3D video includes a texture video having general color picture information and a depth-map video having depth information for the texture video.

The depth-map video stores a distance possessed by each pixel of the picture as a gray scale and a minute depth difference among the respective pixels is not severe in one block and there are many cases in which the depth map video may be expressed as two kinds of a foreground and a background. Further, the depth map video shows a characteristic in which the depth map video has a sharp edge on a boundary of an object and has an almost constant value (constant value) at a location other than the boundary.

Since the intra prediction used to the existing texture video is a prediction method suitable for a constant area having a predetermined value, the intra prediction is not effective to predict the depth map having a different characteristic from the texture video.

Therefore, a new intra prediction mode reflecting the characteristic of the depth map is added in the 3D video coding. In the intra prediction mode for the depth map, the depth map block (alternatively, depth block) is expressed as a model split into two non-rectangular areas and each of the split areas is expressed as the constant value.

As described above, the intra prediction mode to express and predict the depth map block as one model is referred to as a depth modeling mode (DMM). In the DMM, the depth map may be predicted based on partition information indicating how the depth map block is split and information on a value filled in each partition.

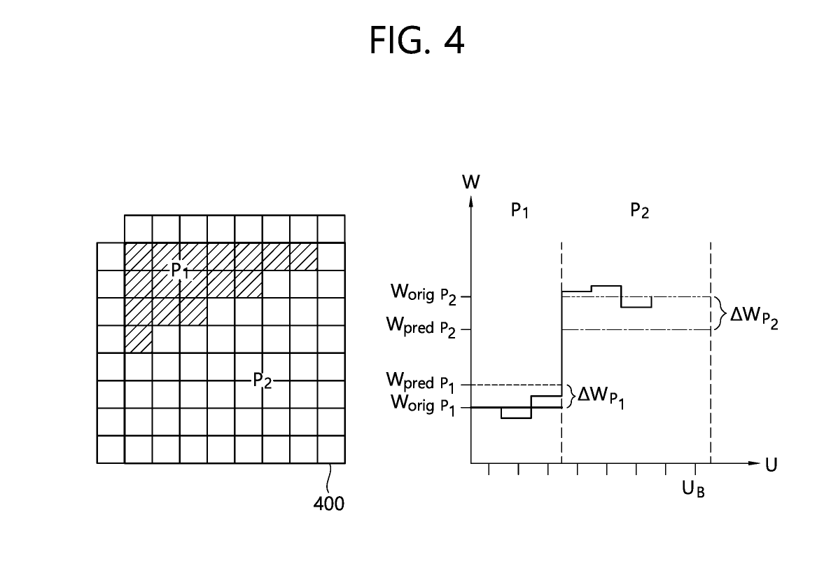

FIG. 4 is a diagram for schematically describing an intra prediction method of a depth map in a depth modeling mode (DMM).

Referring to FIG. 4, when a depth block 400 which becomes an intra prediction target in the depth-map picture is intra-predicted by the DMM, the depth block 400 may be split into two non-rectangular areas P₁ and P₂. The split areas P₁ and P₂ are filled with constant values, respectively.

In this case, as an optimal constant value filling each of the split areas, an average value of original depth values of the respective areas may be used. However, an encoder does not signal the average value of the original depth values but averages values of neighbor samples adjacent to the respective areas to acquire a prediction value and a difference ΔW between the prediction value W_{pred} and the average value W_{orig} of the original depth values is calculated to signal the residual value ΔW. A decoder may reconstruct each area based on the signaled residual value ΔW of the respective areas and the prediction value W_{pred} of each area.

For example, the encoder averages the values of the neighbor samples adjacent the area P1 to acquire a prediction value W_{predP1} of the area P₁ and calculate a difference ΔW_{P1} between the prediction value W_{predP1} of the area P₁ and an average value W_{origP1} of original depth values of the area P₁. The encoder may transmit the calculated difference ΔW_{P1} of the area P1 to the decoder.

The decoder averages the values of the neighbor samples adjacent to the area P1 to acquire the prediction value W_{predP1} of the area P₁ and adds the difference ΔW_{P1} of the area P₁, which is transmitted from the encoder to the prediction value W_{predP1} of the area P₁ to reconstruct the area P₁.

By the same method as the area P₁, a prediction value W_{predP2} of the area P₂ may be derived by using values of neighbor samples adjacent to the area P₂ and a difference ΔW_{P2} between the prediction value W_{predP2} of an the area P₂ and an average value W_{origP2} of original depth values of the area P₂ may be calculated. The decoder may reconstruct the area P₂ based on the values.

When the depth-map picture is coded in the 3D video coding, a residual block may be coded by using a lookup table. In general, values of sample (pixel) values of the depth-map picture are not evenly distributed and are distributed concentratively on a specific area. When the lookup table is generated by considering such a characteristic and the depth value of the depth-map picture is transformed into an index value of the lookup table to be encoded, the number of bits to be encoded may be reduced. Further, the residual block generated by using the lookup table may be entropy-coded without the transformation and quantization processes. Therefore, a coding method of the depth-map picture using the lookup table is referred to as simplified depth coding (SDC).

In the SDC method, the prediction is performed by using the aforementioned depth modeling mode (DMM) and a planar mode unlike the existing intra prediction and residual data generated based on the predicted data are indexed by using a predetermined lookup table without the transformation and quantization processes.

Hereinafter, the SDC method that codes the residual block by using the lookup table will be described in more detail.

A block (hereinafter, referred to as a current block) to be coded currently in the depth-map picture may be intra-predicted by using the DMM or the planar mode. In this case, in the case of the intra prediction using the DMM, as described above, the current block is split into two areas and an average of depth values predicted with respect to the respective areas are acquired to be used as a prediction value. In the case of the intra prediction using the planar mode, since the current block may be one area which is not split, an average of depth values predicted with respect to one area in the current block is acquire to be used as the prediction value.

That is, the average of the depth value intra predicted with respect to the respective split areas (in the case of the DMM, two areas and in the case of the planar, one area) in the current block and an average of original depth values are calculated and the respective calculated average values are mapped to the lookup table to find each index value. In addition, instead of encoding a residual value between the original depth value and the predicted depth value, a residual value between an index of the average of the original depth value mapped from the lookup table and the average of the predicted depth value may be encoded.

Equation 1 given below shows a process of generating a difference index value for the current block by the SDC method.

Res_indexi=DLT[Orgi_DC]−DLT[Predi_DC] [Equation 1]

In Equation 1, i represents the split area in the current block and depth lookup table (DLT) represents a lookup table for a previously generated depth value.

Since the SDC method generates the residual signal by using the average of the prediction value with respect to the split area as described above, the SDC method is also referred to as segment-wise DC coding.

In the aforementioned SDC method, the intra prediction is performed and the residual signal is generated by using the lookup table (hereinafter, referred to as the DLT) for the depth value in the SDC mode (the DMM and the planar mode).

Hereinafter, the present invention proposes the SDC method that uses the DLT even in the intra prediction mode used to predict the texture video in addition to the SDC mode.

The intra prediction mode used to predict the texture video may include a directional mode and a non-directional mode according to directions in which the reference samples used to predict the sample value of the current block and/or a prediction scheme. For example, the intra prediction mode may include 33 directional prediction modes and at least two non-directional prediction modes.

The non-directional prediction mode may include a DC mode and the planar mode. The DC mode may use one fixed value as prediction values of samples in the current block. As one example, in the DC mode, one fixed value may be derived by an average of sample values positioned around the current block. The planar mode may perform vertical interpolation and horizontal interpolation by using a sample vertically adjacent to the current block and a sample horizontally adjacent to the current block and use an average value of the vertical and horizontal interpolation values as the prediction values of the samples in the current block.

The directional prediction mode as a mode indicating a direction in which the reference sample is positioned indicate the corresponding direction at an angle between a prediction target sample in the current block and the reference sample. The directional prediction mode may be referred to as an angular mode and include a vertical mode, a horizontal mode, and the like. The vertical mode may use the sample value vertically adjacent to the current block as the prediction value of the sample in the current block and the horizontal mode may use the sample value horizontally adjacent to the current block as the prediction value of the sample in the current block. In addition, the residual angular mode other than the vertical mode and the horizontal mode may deduce the prediction value of the sample in the current block by using the reference sample positioned at a predetermined angle and/or in a predetermined direction with each mode.

In the intra prediction using the existing intra prediction mode (35 intra prediction modes used to predict the texture video), the residual signal is generated by the unit of the pixel (sample) with respect to one block and the residual signal goes through the transformation and quantization processes and thereafter, is entropy-encoded. However, the intra prediction method using the DLT proposed by the present invention, the DLT is applied to each pixel of an original picture and each pixel of a prediction picture and thereafter, the residual signal is generated by the residual value of the index mapped to the DLT and the residual signal goes through the transformation and quantization processes and thereafter, is entropy-encoded. Therefore, an area of the residual signal generated based on the existing intra prediction is a value area, but an area of the residual signal generated through the intra prediction using the DLT proposed by the present invention is an index area.

Further, in the existing SDC mode, the DLT is applied by the unit of the split area in one block to derive the index residual value, but in the present invention, the DLT is applied by the unit of the pixel in the block to derive the index residual value. Therefore, when the method proposed by the present invention is used, accuracy of the prediction may further increase and a reconstruction picture close to the original picture may be generated.

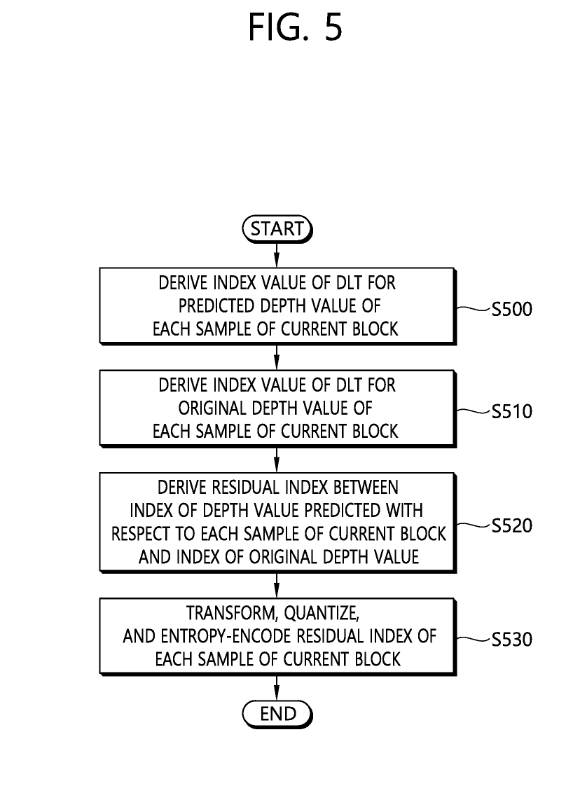

FIG. 5 is a flowchart schematically illustrating a method for encoding by applying intra prediction using a DLT according to an embodiment of the present invention. The method of FIG. 5 may be performed by the video encoding apparatus of FIG. 2.

Referring to FIG. 5, the encoding apparatus performs the prediction based on the intra prediction mode of the block (hereinafter, referred to as the current block) to encoded currently in the depth-map picture to a predicted depth value of each sample in the current block. In addition, the encoding apparatus maps the depth lookup table (DLT) to the derived predicted depth value of each sample of the current block to derive an index value of each DLT (S500).

Herein, the intra prediction mode may be any one of the aforementioned existing intra prediction mode (35 intra prediction modes used to predict the texture video) and a depth map intra prediction mode (the SDC mode including the DMM).

The DLT as the lookup table storing the depth value of the depth-map picture has information in which each depth value is mapped to the index value. In general, values of sample (pixel) values of the depth-map picture are not evenly distributed and are distributed concentratively on a specific area. The index of the DLT may be generated by considering such a feature and the depth value of the depth-map picture may be mapped to (transformed into) the index value.

For example, in the DLT, a depth value of an i-th index may be derived based on a difference between the depth value of the i-th index and a depth value of an (i−1)-th index in the DLT. Therefore, the encoding apparatus may signal the difference between the depth value of the i-th index and the depth value of the (i−1)-th index to the decoding apparatus. The decoding apparatus may derive the depth values in the DLT based on the signal residual value.

The encoding apparatus maps the DLT to the original depth value of each sample of the current block to derive the index value of each DLT (S510).

The encoding apparatus derives a residual index between the index of the depth value predicted with respect to each sample of the current block and the index of the original depth value (S520).

The encoding apparatus may use the residual index value for each sample of the current block as the residual signal.

Equation shows a process of deriving the residual signal according to the embodiment of the present invention.

Res_index[x]=DLT[Org[x]]−DLT[Pred[x]] [Equation 2]

In Equation 2, x represents each sample in the current block. Org[x] represents the original depth value of a sample x in the current block and Pred[x] represents the predicted depth value of the sample x in the current block. DLT[Org[x]] represents transformation of the original depth value of the sample x in the current block into the index value and DLT[Pred[x]] represents transformation of the predicted depth value of the sample x in the current block into the index value of the DLT. Res_index[x] represents the residual index value of the sample x in the current block.

For example, the encoding apparatus maps the DLT to a predicted depth value Pred[x₁] of a first sample in the current block, which is derived based on the intra prediction mode of the current block to derive a first index value DLT[Pred[x₁]] for the first sample in the current block. The encoding apparatus maps the DLT to an original depth value Org[x₁] of the first sample in the current block, which is derived based on the intra prediction mode of the current block to derive a second index value DLT[Org[x₁]] for the first sample in the current block. In addition, the encoding apparatus may derive a residual index value Res_index[x₁] between the first index value DLT[Pred[x₁]] and the second index value DLT[Org[x₁]] for the first sample in the current block. The derived residual index value Res_index[x₁] is used as the residual signal for the first sample in the current block to perform the transformation, quantization, and the entropy encoding of the current block.

The encoding apparatus may transforms, quantizes, and entropy-encodes the residual index value for each sample in the current block (S530).

The residual signal of the current block is generated by using the DLT as described above to reduce the number of bits to be encoded and the DLT is applied even to the existing intra prediction mode in addition to the SDC mode to increase encoding efficiency.

According to the embodiment of the present invention, in the encoding method using the DLT, the encoding may be performed by using the DLT only when the current block has a size of 2N×2N in order to reduce complexity. The intra prediction is performed even in a block size of N×N in addition to the block size of 2N×2N. However, in most cases, since the intra prediction is performed in the block size of 2N×2N, the aforementioned steps S500 to S530 by applying the DLT when the current block has the size of 2N×2N in order to reduce the complexity in the present invention.

Further, in the present invention, in the encoding method using the DLT, the encoding may be performed by using the DTL only in the case of a specific intra prediction mode in order to reduce the complexity. In general, since samples in the prediction sample are generated by applying an interpolation filter in residual intra prediction modes other than the DC mode, the horizontal mode, and the vertical mode among the intra prediction modes, all values of the samples in the prediction block are different from each other. In this case, applying the DLT as an average value of all samples in the block decreases the encoding efficiency. Accordingly, in the present invention, instead of applying the DLT to all of the intra prediction modes, the DLT is applied only to the DC mode, the horizontal mode, the vertical mode, and the depth map intra prediction mode that generate the prediction mode without applying the interpolation filter to perform the aforementioned steps S500 to S530. In this case, the encoding apparatus need not encode information (for example, a DLT flag) indicating whether the DLT is applied and has a gain in which the complexity decreases.

Meanwhile, the encoding apparatus compares a residual signal generated by using the value and a residual signal generated by using the index in terms of rate distortion optimization (RDO) in order to select an optimal intra prediction mode for the current block. In this case, since the encoding apparatus performs the RDO twice for each of all intra prediction modes, the complexity may increase. Hereinafter, the present invention provides a method for selecting the optimal intra prediction mode in order to reduce the complexity in the encoding method using the DLT.

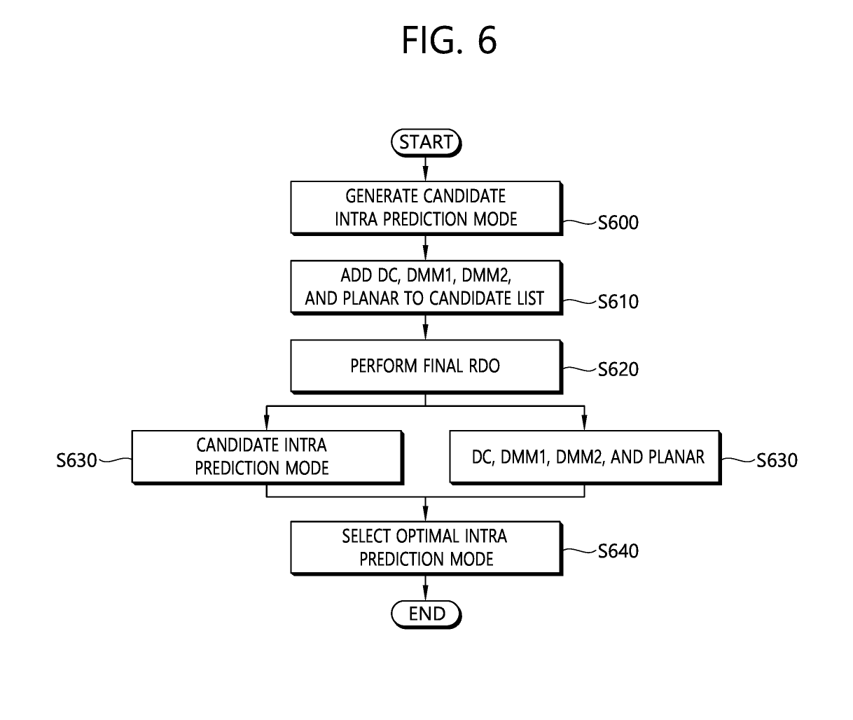

FIG. 6 is a flowchart schematically illustrating a method for selecting an optimal intra prediction mode according to an embodiment of the present invention.

The encoding apparatus may perform a process given below in order to decide the intra prediction mode a block (current block) in which the prediction is currently performed.

Referring to FIG. 6, the encoding apparatus generates 8 candidate intra prediction modes having low cost among 35 existing intra prediction modes through simplified RDO and selects 4 candidate intra prediction modes having low cost among 8 candidate intra prediction modes again (S600). In this case, a candidate list may be generated based on 4 candidate intra prediction modes.

Herein, 4 candidate intra prediction modes are finally selected among 35 existing intra prediction modes, but this is just one example and the number of candidate modes may be variably controlled.

The encoding apparatus adds the depth map intra prediction modes (for example, the DMM, the DC mode, and the planar mode) to the candidate list constituted by 4 candidate intra prediction modes (S610). In this case, how many modes among the depth map intra prediction modes are to be added may be variably controlled.

The encoding apparatus performs final RDO (full RDO) with respect to the candidate list constituted by 4 candidate intra prediction modes and the depth map intra prediction modes (S620).

The encoding apparatus compares cost of 4 candidate intra prediction modes and cost of the depth map intra prediction modes (for example, the DMM, the DC mode, and the planar mode) which are acquired through the final RDO (S630) and selects the optimal intra prediction mode having low cost (S640).

The encoding apparatus may decide the selected optimal intra prediction mode as the intra prediction mode used for intra-predicting the current block and signal information on the intra prediction mode of the current block to the decoding apparatus.

When the depth map intra prediction mode is selected as the optimal intra prediction mode, the encoding apparatus may signal information indicating that the intra prediction is performed by using the depth map intra prediction mode to the decoding apparatus. On the contrary, when the existing intra prediction mode is selected as the optimal intra prediction mode, the encoding apparatus may signal information indicating that the depth map intra prediction mode is not used to the decoding apparatus. That is, the encoding apparatus may signal flag information indicating whether to use the depth map intra prediction mode.

Further, the encoding apparatus may decide whether to perform the intra prediction encoding using the DLT through the aforementioned steps S600 to S640 by considering rate distortion cost and signal information indicating whether the DLT is used to the decoding apparatus.

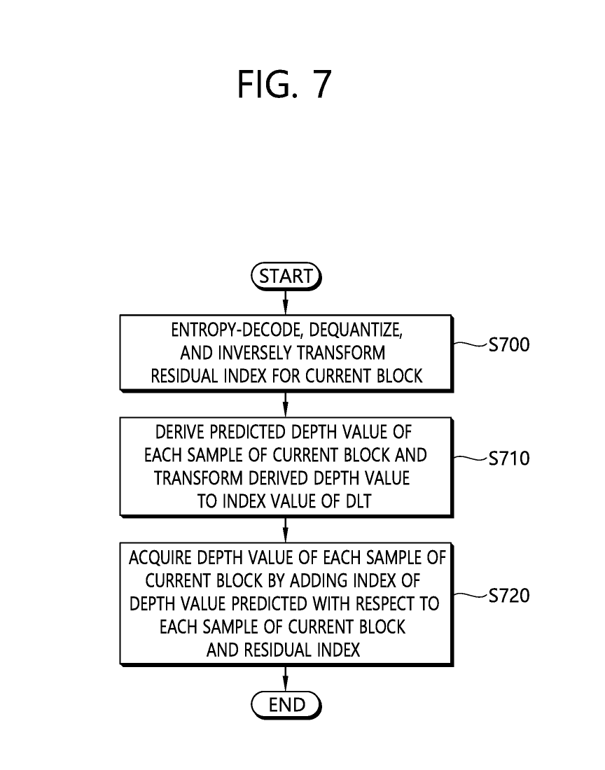

FIG. 7 is a flowchart schematically illustrating a method for decoding by applying intra prediction using a DLT according to an embodiment of the present invention. The method of FIG. 7 may be performed by the video decoding apparatus of FIG. 3.

Referring to FIG. 7, the decoding apparatus acquires the residual index value for a block (hereinafter, referred to as the current block) to be currently decoded in the depth-map picture through entropy decoding, dequantization, and inverse transformation (S700).

The decoding apparatus performs the prediction based on the intra prediction mode of the current block to derive the predicted depth value of each sample of the current block. In addition, the decoding apparatus maps the depth lookup table (DLT) to the derived predicted depth value of each sample of the current block to derive the index value of each DLT (S710).

Herein, the intra prediction mode may be any one of the aforementioned existing intra prediction mode (35 intra prediction modes used to predict the texture video) and the depth map intra prediction mode (the SDC mode including the DMM).

Alternatively, the intra prediction mode may be a specific intra prediction mode and for example, any one of the DC mode, the horizontal mode, the vertical mode, and the depth map intra prediction mode.

As described above, the DLT as the lookup table storing the depth value of the depth-map picture has the information in which each depth value is mapped to the index value.

For example, in the DLT, the depth value of the i-th index may be derived based on the difference between the depth value of the i-th index and the depth value of the (i−1)-th index in the DLT. The decoding apparatus may derive the depth values in the DLT based on the difference value between the indexes signaled from the encoding apparatus.

The decoding apparatus adds the index of the depth value predicted with respect to each sample of the current block and the residual index to acquire the depth value of each sample in the current block (S720).

For example, the decoding apparatus may acquire the residual index value Res_index[x] for the current block through the entropy decoding, the dequantization, and the inverse transformation. The decoding apparatus may derive the predicted depth value Pred[x₁] of the first sample of the current block based on the intra prediction mode of the current block. In addition, the decoding apparatus maps the DLT to the predicted depth value Pred[x₁] of the current block to derive the first index value DLT[Pred[x₁]] for the first sample in the current block. The decoding apparatus adds the first index value DLT[Pred[x₁]] for the first sample of the current block and the residual index value Res_index[x₁] to reconstruct the depth value of the first sample in the current block. In this case, the depth value of the first sample in the current block is a value acquired by mapping the second index value DLT[Pred[x₁]]+Res_index[x₁] derived by adding the first index value and the residual index value to the DLT and transforming the mapped second index value into the depth value.

As described above, in the present invention, in order to reduce the complexity, the aforementioned steps S700 to S720 may be performed when the current block has the size of 2N×2N.

In the aforementioned illustrated system, methods have been described based on flowcharts as a series of steps or blocks, but the methods are not limited to the order of the steps of the present invention and any step may occur in a step or an order different from or simultaneously as the aforementioned step or order. The aforementioned embodiments include examples of various aspects. Therefore, all other substitutions, modifications, and changes of the present invention that belong to the appended claims can be made.

1. A method for coding a 3D video including a depth-map picture, the method comprising:
deriving a first index value with respect to a first sample of a current block by mapping a predicted depth value of the first sample of the current block on a depth lookup table (DLT), wherein predicted depth value of the first sample has been induced based on an intra-prediction mode of the current block in a depth-map picture;
deriving a second index value with respect to the first sample of the current block by mapping an original depth value of the first sample of the current block on the DLT;
deriving a residual index value between the first index value and the second index value with respect to the first sample of the current block; and
transforming, quantizing, and entropy-coding the residual index value.

2. The method of claim 1, wherein:
the size of the current block is 2N×2N, and
the current block includes 2N×2N samples.

3. The method of claim 1, wherein the intra prediction mode of the current block is any one of a DC mode, a vertical mode, a horizontal mode, and a depth map intra prediction mode.

4. The method of claim 1, wherein the DLT is a lookup table generated by mapping the depth value of the depth-map picture to the index value.

5. The method of claim 4, wherein in the DLT, the depth value of an i-th index is derived based on a difference between the depth value of the i-th index and a depth value of an (i−1)-th index in the DLT.

6. A method for decoding a 3D video including a depth-map picture, the method comprising:
acquiring a residual index value for a current block in the depth-map picture through entropy-decoding, dequantization, and inverse transformation;
deriving a predicted depth value of a first sample in the current block based on an intra prediction mode of the current block;
deriving a first index value for the first sample in the current blocking by mapping the predicted depth value of the first sample of the current block on a DLT; and
acquiring the depth value of the first sample of the current block by adding the first index value and the residual index value with respect to the first sample of the current block,
wherein the depth value of the first sample of the current block is a value acquired by mapping a second index value derived by adding the first index value and the residual index value to the DLT.

7. The method of claim 6, wherein:
the size of the current block is 2N×2N, and
the current block includes 2N×2N samples.

8. The method of claim 6, wherein the intra prediction mode of the current block is any one of a DC mode, a vertical mode, a horizontal mode, and a depth map intra prediction mode.

9. The method of claim 6, wherein the DLT is a lookup table generated by mapping the depth value of the depth-map picture to the index value.

10. The method of claim 9, wherein in the DLT, the depth value of an i-th index is derived based on a difference between the depth value of the i-th index and a depth value of an (i−1)-th index in the DLT.

11. An encoding apparatus for coding a 3D video including a depth-map picture, the apparatus comprising:
a prediction unit configured to induce a predicted depth value of the first sample based on an intra-prediction mode of a current block in a depth-map picture;
a subtraction unit configured to derive a first index value with respect to the first sample of the current block by mapping the predicted depth value of the first sample of the current block on a depth lookup table (DLT), derive a second index value with respect to the first sample of the current block by mapping an original depth value of the first sample of the current block on the DLT, and derive a residual index value between the first index value and the second index value with respect to the first sample of the current block;
a transform unit configured to perform transform on the residual index value;
a quantization unit configured to perform quantization on a result of the transform; and
a entropy encoding unit configured to perform entropy encoding on a result of the quantization.

12. The apparatus of claim 11, wherein:
the size of the current block is 2N×2N, and
the current block includes 2N×2N samples.

13. The apparatus of claim 11, wherein the intra prediction mode of the current block is any one of a DC mode, a vertical mode, a horizontal mode, and a depth map intra prediction mode.

14. The apparatus of claim 11, wherein the DLT is a lookup table generated by mapping the depth value of the depth-map picture to the index value.

15. The apparatus of claim 14, wherein in the DLT, the depth value of an i-th index is derived based on a difference between the depth value of the i-th index and a depth value of an (i−1)-th index in the DLT.

16. A decoding apparatus for decoding a 3D video including a depth-map picture, the apparatus comprising:
an entropy decoding unit configured to perform entropy-decoding on information on a residual index value for a current block in the depth-map picture;
a dequantization unit configured to acquire a residual index value for the current block in the depth-map picture by performing dequantization on a result of the entropy-decoding;
an inverse transform unit configured to perform invers transform on a result of the dequantization;
a prediction unit configured to derive a predicted depth value of a first sample in the current block based on an intra prediction mode of the current block;
an adding unit configured to derive a first index value for the first sample in the current block by mapping the predicted depth value of the first sample of the current block on a DLT, and acquire the depth value of the first sample of the current block by adding the first index value and the residual index value with respect to the first sample of the current block,
wherein the depth value of the first sample of the current block is a value acquired by mapping a second index value derived by adding the first index value and the residual index value to the DLT.

17. The apparatus of claim 16, wherein:
the size of the current block is 2N×2N, and
the current block includes 2N×2N samples.

18. The apparatus of claim 16, wherein the intra prediction mode of the current block is any one of a DC mode, a vertical mode, a horizontal mode, and a depth map intra prediction mode.

19. The apparatus of claim 16, wherein the DLT is a lookup table generated by mapping the depth value of the depth-map picture to the index value.

20. The apparatus of claim 19, wherein in the DLT, the depth value of an i-th index is derived based on a difference between the depth value of the i-th index and a depth value of an (i−1)-th index in the DLT.
